(19) United States
(12) Patent Application Publication
(10) Pub. No.: US 2008/0035690 A1
(43) Pub. Date: Feb. 14, 2008

(54) Adjustment structure for a bicycle lock holding dock

(75) Inventor: Chin-Hui Hsai, Chang Hua (TW)

Correspondence Address: BRUCE H. TROXELL;SUITE 1404, 5205 LEESBURG PIKE, FALLS CHURCH, VA, 22041, US

(73) Assignee: HANDYWAY CO., LTD.

(21) Appl. No.: 11/503,273

(22) Filed: Aug. 14, 2006

(51) Int. Cl. B62J 11/00; B62J 9/00

(52) U.S. Cl. 224/425; 224/448

(57) ABSTRACT

An adjustment structure for a bicycle lock holding dock to adjust hanging angle of a lock without using any tools. It has an anchor seat to be fastened to the bicycle frame. The anchor seat has a coupling portion on a front side to fasten to a sleeve. The sleeve has a plurality of notches on an inner rim close to one end to be latched by a jutting latch member formed on the periphery of a rotary member. The rotary member has a housing chamber to hold, in this order, a pushbutton, a thrust member, a first spring, a spacer and a second spring, and a wedge trough on another end to be coupled with the lock. By pushing the rotary member, the latch member can escape from the notches so that the rotary member can be rotated to alter the angle of the wedge trough. Thereby the hanging angle of the lock can be adjusted according to user's requirements.

### BACKGROUND OF THE INVENTION

1. Field of the Invention

The present invention relates to an adjustment structure for a bicycle lock holding dock and particularly to an adjustment structure for a holding dock that can rotate the hanging angle of a bicycle lock according to requirements without using tools.

2. Description of the Prior Art

A conventional bicycle lock holding dock such as the one disclosed in R.O.C. patent No. 85213281 has an anchor clipping member and an adjusting member that are fastened together through a fastening element (bolt). A coupling portion and a coupling trough are provided that are engageable to adjust the angle. In the event that the fastening position of the anchor clipping member on the bicycle cannot provide users a required angle, the angle of the adjusting member has to be altered. And a tool is needed to unfasten the bolt that fastens the anchor clipping member and the adjusting member. Next the coupling portion is separated from the coupling trough to rotate the adjusting member. Then the bolt is fastened again through the tool. Such an adjustment process has to rely the tool and requires a complicated procedure. It cannot meet the modem requirement that demands fast and simple operation. Moreover, carrying the tool is troublesome for users.

### SUMMARY OF THE INVENTION

In view of the aforesaid problems occurred to the conventional bicycle lock holding dock, the present invention aims to provide an improved adjustment structure that can do adjustment simply and quickly to eliminate the problems.

The primary object of the invention is to provide an adjustment structure for a bicycle lock holding dock that can adjust the hanging angle of a bicycle lock by rotating without using tools. The adjustment structure of the invention includes an anchor seat, a sleeve, a rotary member, a pushbutton, a thrust member and a spacer. The anchor seat is fastened to a bicycle frame, and has a coupling portion on a front side to fasten to the sleeve. The sleeve has a plurality of notches on an inner rim of one end to be latched by lugs formed on the periphery of the rotary member to form an anchoring condition. The one end also has a housing chamber with an opening to hold, in this order, the pushbutton, thrust member, a first spring, the spacer and a second spring. The rotary member has a wedge trough on another end to hold a lock. The rotary member is pushed by the second spring so that the lugs are latched in the notches of the sleeve in normal conditions. When the rotary member is pushed to compress the second spring, the lugs escape from the notches, and rotating adjustment can be performed to alter the angle of the wedge trough. Therefore the lock can be hung at a desired angle according to user's requirement.

By means of the construction set forth above, adjustment can be done quickly and simply without using any tools. Operation is easier and the trouble of carrying tools can be dispensed with. It offers a significant improvement over the conventional techniques.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 2-1 is a perspective view of the pushbutton of the invention.

FIG. 3 is a sectional view of the invention.

FIG. 4 is a cross section taken on line I-I in FIG. 3.

FIG. 5 is a sectional view of the invention in an operating condition.

FIG. 6 is a cross section taken on line II-II in FIG. 5.

FIG. 7 is a sectional view of the invention in another operating condition.

FIG. 8 is a schematic view of an embodiment of the invention.

### DESCRIPTION OF THE PREFERRED EMBODIMENT

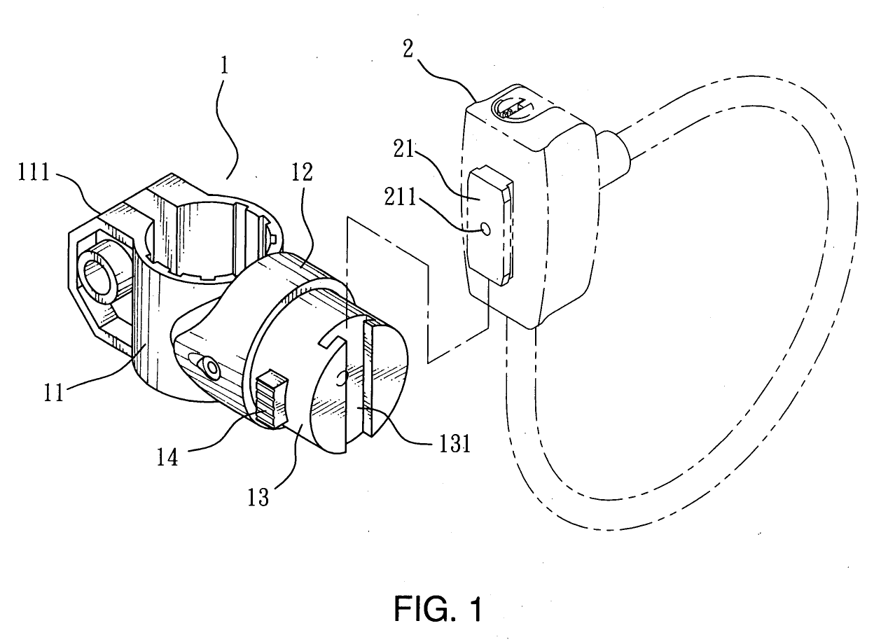

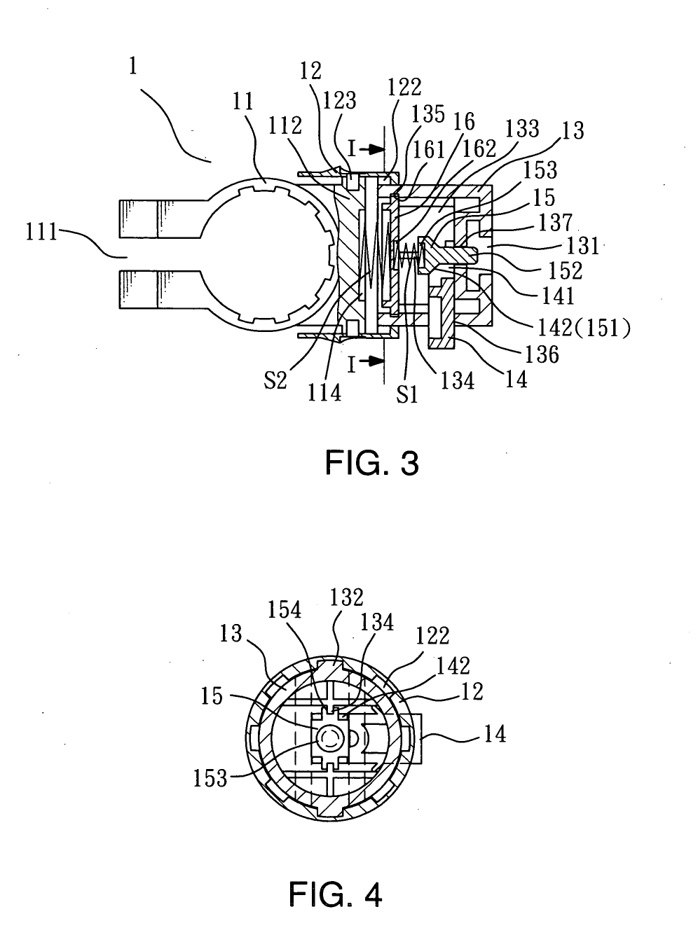

Referring to FIGS. 1 through 4, the adjustment structure according to the invention includes an anchor seat 11, a sleeve 12, a rotary member 13, a pushbutton 14, a thrust member 15 and a spacer 16.

The anchor seat 11 is formed in a tubular fashion and fastened to a bicycle frame. It has a fastening portion 111 on one side to be coupled with a screw for fastening and a coupling portion 112 on another side that has respectively a round hole 113 on two lateral sides and a recess 114 at a front end.

The sleeve 12 is a hollow barrel with an aperture 121 on each of two sides to receive a pin 123 which also runs through the round holes 113 so that the sleeve 12 is fastened to the anchor seat 11. The sleeve 12 further has a plurality of notches 122 on an inner rim close to one end thereof.

The rotary member 13 is held in the sleeve 12, and has at least one wedge trough 131 on a front end to be wedged in by a latch portion 21 of a lock 2, and at least one latch member 132 jutting from the periphery of a rear end thereof to be latched in the notches 122 of the sleeve 12. It also has a housing chamber 133 which has an opening to receive, in this order, the pushbutton 14, the thrust member 15, a first spring S1, the spacer 13 and a second spring S2. The housing chamber 133 has two guiding ribs 134 and an annular groove 135, and an opening 136 on one side, and an orifice 137 on a front side to communicate with the wedge trough 131.

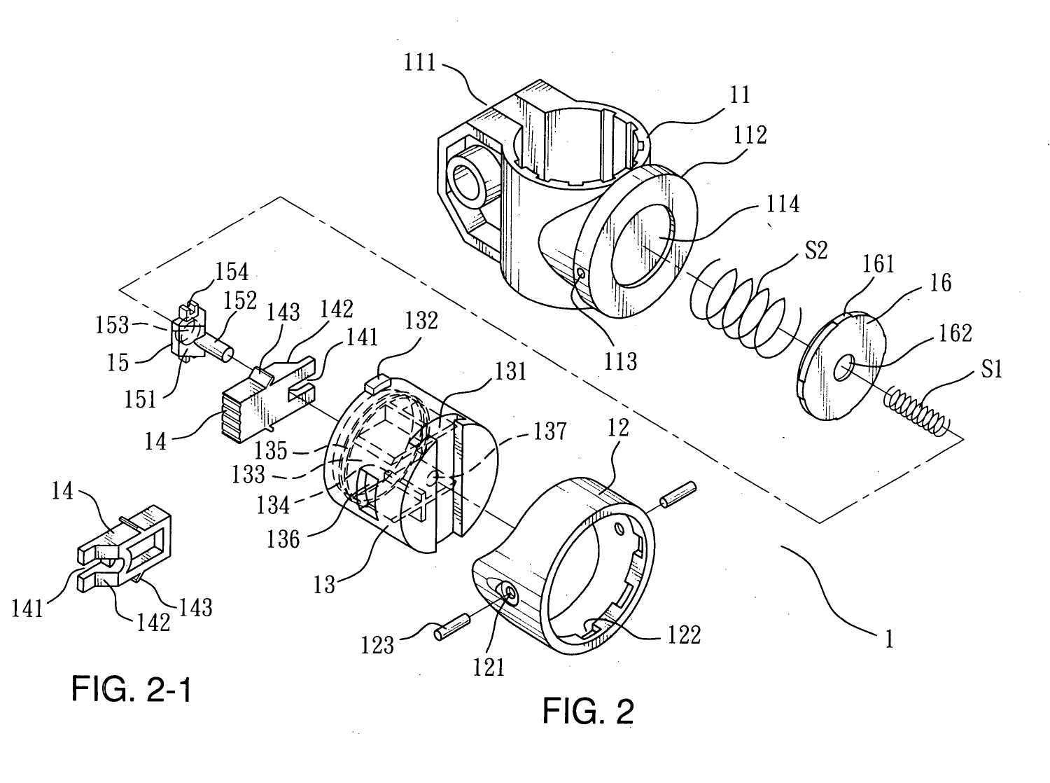

The pushbutton 14 (also referring to FIG. 2-1) is located in the housing chamber 133, and has one end extended outside the opening 136 and another end forming a slot 141 and a first slant surface 142, and a detent flange 143 on a upper side and a lower side thereof.

The thrust member 15 is located in the housing chamber 133, and has a second slant surface 151 mating and bucking the first slant surface 142 of the pushbutton 14. It also has a strut 152 on one end inserting into the orifice 137 of the rotary member 13, and a cavity 153 on another end to hold the first spring S1. It further has respectively a guiding trough 154 on a upper side and a lower side to couple with the guiding rib 134.

The spacer 16 is located in the housing chamber 133, and has a plurality of lugs 161 on the periphery to be wedged in the annular groove 135. It also has another cavity 162 on a front side to hold the first spring S1, and another side to be pressed by one end of the second spring S2. The second spring S2 has another end pressing the recess 114 of the anchor seat 11.

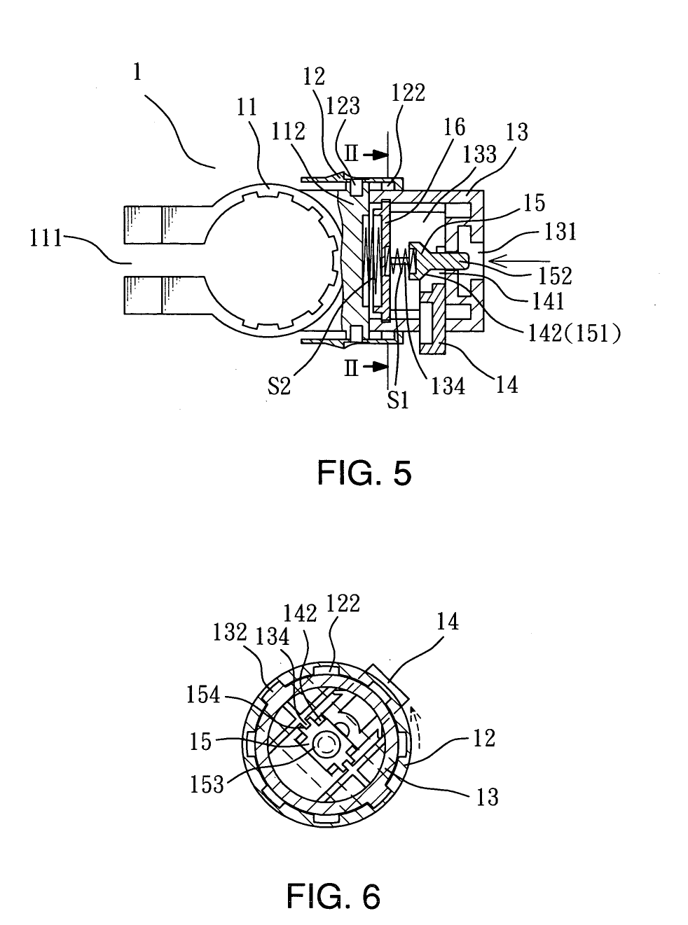

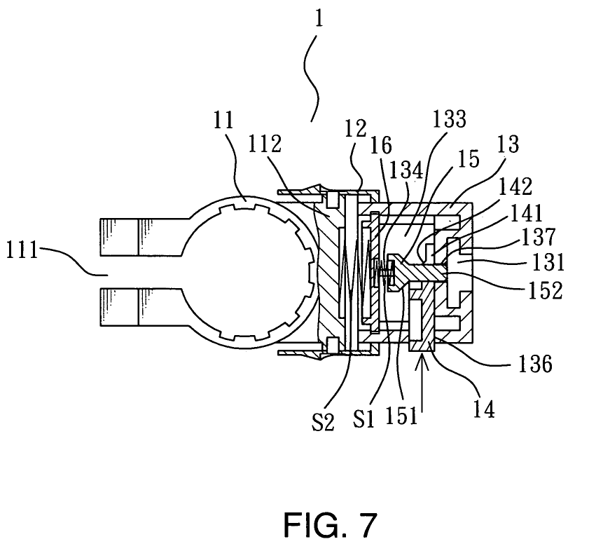

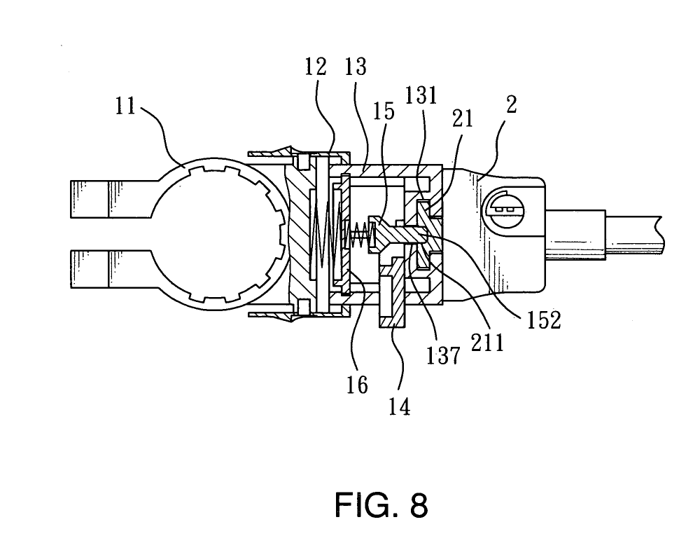

In the bicycle holding dock 1 thus formed, the rotary member 13 is pushed by the second spring S2 so that the latch member 132 is latched in the notches 122 of the sleeve 12 in normal conditions to form an anchoring condition. When there is a desire to change the angle of the wedge trough 131, push the rotary member 13 towards the anchor seat 11, the latch member 132 escapes from the notch 122, then the rotary member 13 can be rotated (referring to FIGS. 5 and 6). The rotary member 13 may be released after having been rotated to a required angle, then the rotary member 13 is pushed by the returning elastic force of the second spring S2 so that the latch member 132 is wedged in the notch 122 again. Thereby the wedge trough 131 is adjusted at the desired angle. By depressing the pushbutton 14, the thrust member 15 is moved rearwards along the guiding rib 134 to retract the strut 152 into the orifice 137. Hence the latch portion 21 of the lock 2 can be wedged in, and the first spring Si is in a compressed condition (referring to FIG. 7). When the pushbutton 14 is released, the returning elastic force of the first spring SI pushes the strut 152 to extend through the orifice 137 to latch in a latch hole 211 of the latch portion 21. Thereby the lock 2 can be anchored (referring to FIG. 8).

In short, the invention provides a simple adjustment operation by pushing and rotating. Adjustment can be done whenever desired without using any tools. It eliminates the trouble of carrying tools occurred to the conventional techniques and offers a significant improvement.

I claim:

1. An adjustment structure for a bicycle lock holding dock comprising an anchor seat, a sleeve, a rotary member, a pushbutton, a thrust member and a spacer, wherein:
the anchor seat is fastened to a bicycle frame and has a fastening portion on one side and a coupling portion on another side;
the sleeve is a hollow barrel to be fastened to the anchor seat;
the rotary member is located in the sleeve and has at least one wedge trough on a front end and a housing chamber inside that has an opening;
the pushbutton is located in the housing chamber and has a slot and a first slant surface;
the thrust member is located in the housing chamber and has a second slant surface mating and bucking the first slant surface; and
the spacer is located in the housing chamber and has a front side coupling with a first spring and another side pressing a second spring.

2. The adjustment structure of claim 1, wherein the sleeve has a plurality of notches formed on an inner rim in an annular manner close to one end thereof.

3. The adjustment structure of claim 1, wherein the rotary member has at least one jutting latch member on the periphery of a rear end thereof.

4. The adjustment structure of claim 1, wherein the housing chamber has two guiding ribs and an annular groove, an opening on one lateral side and an orifice on a front side communicating with the wedge trough.

5. The adjustment structure of claim 1, wherein the pushbutton has respectively a detent flange on a upper side and a lower side thereof.

6. The adjustment structure of claim 1, wherein the thrust member has a strut on one end.

7. The adjustment structure of claim 1, wherein the thrust member has a cavity to hold the first spring.

8. The adjustment structure of claim 1, wherein the spacer has a plurality of jutting lugs on the periphery thereof.
